(19) United States
(12) Patent Application Publication
(10) Pub. No.: US 2022/0162905 A1
(43) Pub. Date: May 26, 2022

(54) SAFETY GATE

(71) Applicant: Yangfei Huang, GUANGZHOU (CN)

(72) Inventor: Yangfei Huang, GUANGZHOU (CN)

(21) Appl. No.: 17/135,680

(22) Filed: Dec. 28, 2020

(30) Foreign Application Priority Data
Nov. 25, 2020 (CN) 202022770011.1

(51) Int. Cl. E06B 9/18; E06B 9/56

(52) U.S. Cl. CPC E06B 9/18; E06B 2009/002; E06B 9/56

(57) ABSTRACT

Disclosed is a safety gate that includes a first fixing mechanism, a second fixing mechanism, a connection mechanism, a return spring, a screen rolling tube, and a rollup screen operative to be wound on the screen rolling tube. One end of the screen rolling tube is provided with a first mounting mechanism, and the other end is provided with a second mounting mechanism. One end of the return spring passes through the screen rolling tube to be fixedly connected to one end of the rollup screen, and the other end of the return spring is fixedly connected to the first mounting mechanism. A locking mechanism is provided in the second mounting mechanism for locking or unlocking the screen rolling tube, and is fixedly connected to the screen rolling tube. The other end of the rollup screen is provided with a handle mechanism.

### CROSS-REFERENCE TO RELATED APPLICATIONS

This is a U. S. patent application which claims the priority and benefit of Chinese patent application number 202022770011. 1, filed on Nov. 25, 2020, the disclosure of which is incorporated herein by reference in its entirety.

### TECHNICAL FIELD

This disclosure relates to the technical field of doorway gates, and more particularly relates to a safety gate.

### BACKGROUND

In daily life, there are some areas in the home that children are not allowed to enter and leave at will without the care of adults, such as the kitchen, bathroom, stairway, balcony, or other areas, so as to prevent potential accidents from happening. For purposes of restricting the range of children's activities, barriers such as doorway gates are usually installed in these areas.

However, when installing an existing doorway gate, the two ends of the doorway gate usually need to be directly mounted to the upper and lower sides of the contact object such as a wall or a door frame. Such installation method, however, would not only damage the contact object, e. g., the wall or door frame, but also increase the worker's work intensity.

### SUMMARY

In view of the shortcomings of the related art, it is one objective of this disclosure to provide a safety gate, which is not only more convenient to install, but also can accommodate to the installation dimensions of different specifications.

The above-mentioned technical objective of this disclosure is realized through the following technical solution. There is provided a safety gate that includes a first fixing mechanism, a second fixing mechanism, a connection mechanism, a return spring, a screen rolling tube, and a rollup screen that is operative to be wound on the screen rolling tube. One end of the screen rolling tube is provided with a first mounting mechanism, and the other end of the screen rolling tube is provided with a second mounting mechanism. One end of the return spring passes through the screen rolling tube to be fixedly connected to one end of the rollup screen, and the other end of the return spring is fixedly connected to the first mounting mechanism. A locking mechanism is provided in the second mounting mechanism and used for locking or unlocking the screen rolling tube. The locking mechanism is fixedly connected to the screen rolling tube. The other end of the rollup screen is provided with a handle mechanism for pulling the rollup screen. One end of the connection mechanism is fitted with the first fixing mechanism, and the other end is fitted with the second fixing mechanism. The first mounting mechanism and the second mounting mechanism are both fixedly installed on the first fixing mechanism. The second fixing mechanism is provided with a limit mechanism that is operative to be engaged with the handle mechanism.

In summary, the present disclosure provides the following beneficial effects.

1. When installing the safety gate according to the present disclosure, the first mounting mechanism and the second mounting mechanism are fixed to the first fixing mechanism, the hook seat is fixed to the second fixing mechanism, and the first fixing mechanism and the second fixing mechanism are connected together by the connection mechanism. Thus, the contact object such as the wall or door frame would not necessarily be damaged by the installation of the safety gate, making the installation more convenient.

2. When transporting the safety gate of the present disclosure, the connection mechanism, the first fixing mechanism, and the second fixing mechanism can be first separated, and then assembled together after reaching the destination, thus facilitating the packaging and transportation of the safety gate.

3. The safety gate of the present disclosure can adjust the length of the connection mechanism to achieve the purpose of adjusting the distance between the first fixing mechanism and the second fixing mechanism, making the safety gate more adaptable.

### BRIEF DESCRIPTION OF DRAWINGS

FIG. 1 is an assembly diagram of a safety gate according to a first embodiment of the present application.

FIG. 2 is a schematic diagram illustrating the safety gate of the first embodiment when assembled.

FIG. 3 is a schematic diagram of the first support assembly and the second support assembly in the safety gate of the first embodiment.

FIG. 4 is a schematic diagram of a first mounting mechanism in the safety gate according to the first embodiment.

FIG. 5 is a schematic diagram illustrating the second mounting mechanism in the safety gate according to the first embodiment.

FIG. 6 is a schematic diagram illustrating an engagement piece, a locking groove, and an unlocking groove in the safety gate according to the first embodiment.

FIG. 7 is a schematic diagram illustrating fixing gear and limit blocks in the safety gate according to the first embodiment.

FIG. 8 is a schematic diagram illustrating a screen rolling tube and a limit groove in the safety gate according to the first embodiment.

FIG. 9 is a schematic diagram of a first hook seat in the safety gate according to the first embodiment.

FIG. 10 is a schematic diagram of a first rod plug in the safety gate according to the first embodiment.

FIG. 11 is a schematic diagram of a handle mechanism in a safety gate according to a second embodiment of the present application.

FIG. 12 is an enlarged view of portion A shown in FIG. 11.

FIG. 13 is a schematic diagram of a handgrip in the safety gate according to the second embodiment.

FIG. 14 is a schematic diagram of a first sleeve tube in the safety gate according to the second embodiment.

FIG. 15 is a schematic diagram of the safety gate according to the second embodiment.

In the drawings:

| | | | |
|---|---|---|---|
| 1. | First T-shaped rod | 2. | Second T-shaped rod |
| 3. | Connection mechanism | 301. | Connecting rod |
| 302. | First connecting head | 303. | Second connecting head |
| 4. | Return spring | 5. | Screen rolling tube |
| 6. | Rollup screen | 7. | First mounting mechanism |
| 71. | First mounting seat | 72. | Rolling tube pad |
| 73. | Pressure ring | 74. | First washer |
| 75. | Soft pad | 8. | Second mounting mechanism |
| 81. | Second mounting seat | 82. | Mounting sleeve |
| 83. | Second washer | 9. | Handle mechanism |
| 91. | Pull rod | 92. | First rod plug |
| 93. | Second rod plug | 10. | Limit mechanism |
| 101. | First hook seat | 102. | Second hook seat |
| 11. | Stopping block | 12. | First support assembly |
| 121. | First pipe plug | 122. | First screw rod |
| 123. | First adjusting nut | 13. | Second support assembly |
| 131. | Second pipe plug | 132. | Second screw rod |
| 133. | Second adjusting nut | 134. | Fixing pipe |
| 14. | First notch | 15. | Locking mechanism |
| 151. | Fixing gear | 152. | Locking spring |
| 153. | Knob | 154. | Slide aiding pad |
| 16. | Snap protrusion | 17. | Locking groove |
| 18. | Releasing groove | 19. | Limit block |
| 20. | Limit slot | 21. | Slide groove |
| 22. | Engagement piece | 23. | Recess groove |
| 24. | Steel bar | 25. | Mark |
| 26. | Fixing Slot | 27. | Second notch |
| 28. | Third notch | 29. | First fixing seat |
| 30. | Second fixing seat | 31. | Pull pipe |
| 32. | First sleeve tube | 33. | Second sleeve tube |
| 34. | Handgrip | 35. | Locking button |
| 36. | First elastic piece | 37. | Linkage rod |
| 38. | Second elastic piece | 39. | Bolt |
| 40. | Static button hole | 41. | Guide hole |
| 42. | Movable button hole | 43. | Linkage column |
| 44. | Support block | 45. | Through hole |

### DETAILED DESCRIPTION

For a better understanding of the objectives, features and advantages of this disclosure, the specific implementations of this disclosure will be described in detail below in connection with the accompanying drawings. Several embodiments according to this disclosure are illustrated in the drawings. However, this disclosure may be implemented in many different forms and will not be limited to the embodiments described herein.

### First Embodiment

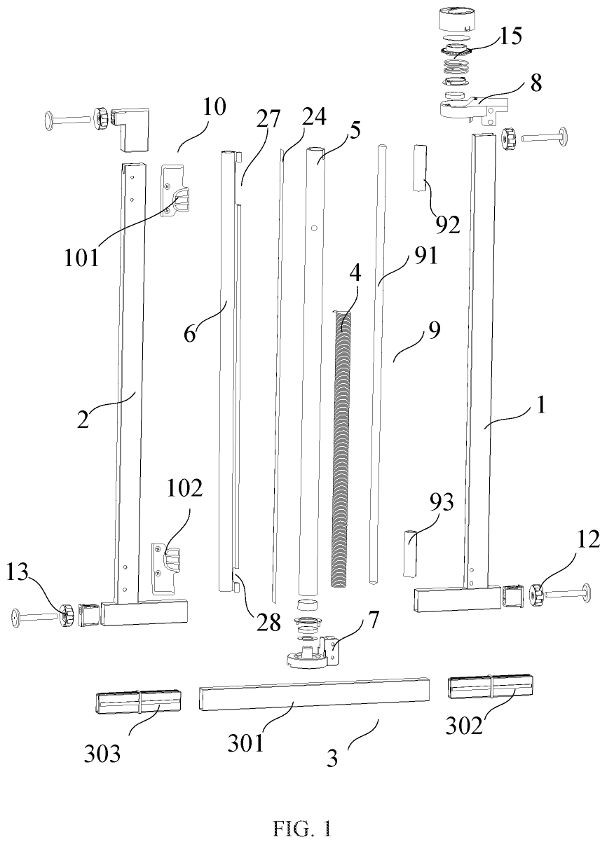

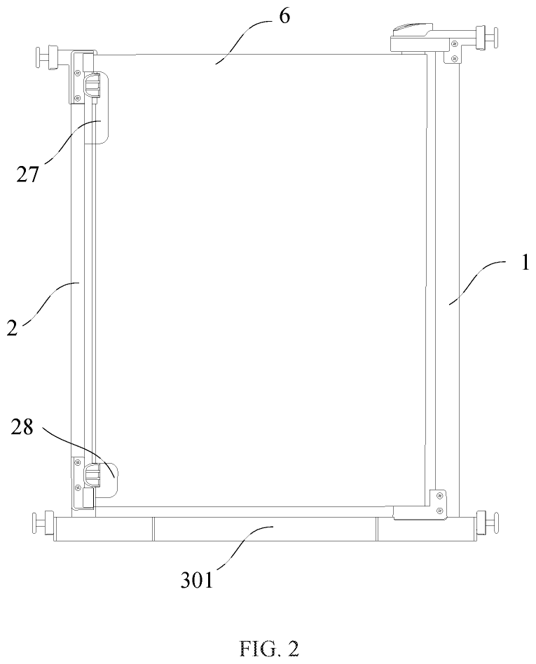

This embodiment provides a safety gate as illustrated in FIGS. 1 and 2. The safety gate includes a first fixing mechanism, a second fixing mechanism, a connection mechanism 3, a return spring 4, a screen rolling tube 5, and a rollup screen 6 that is operative to be wound on the screen rolling tube 5. One end of the screen rolling tube 5 is provided with a first mounting mechanism 7, and the other end of the screen rolling tube 5 is provided with a second mounting mechanism 8. One end of the return spring 4 passes through the screen rolling tube 5 to be fixedly connected to one end of the rollup screen 5, and the other end of the return spring 4 is fixedly connected to the first mounting mechanism 7. A locking mechanism 15 is provided in the second mounting mechanism 8 and used for locking or unlocking the screen rolling tube 5. The locking mechanism 15 is fixedly connected to the screen rolling tube 5. The other end of the rollup screen 6 is provided with a handle mechanism 9 for pulling out the rollup screen 6. One end of the connection mechanism 3 is fitted with the first fixing mechanism, and the other end is fitted with the second fixing mechanism. The first mounting mechanism 7 and the second mounting mechanism 8 are both fixedly installed on the first fixing mechanism. The second fixing mechanism is provided with a limit mechanism 10 that is operative to be engaged with the handle mechanism 9.

In practical applications, the first mounting mechanism 7 and the second mounting mechanism 8 of the screen rolling tube 5 may first be fixed to the first fixing mechanism, and then the limit mechanism 10 may be fixed to the second fixing mechanism, and the first fixing mechanism and the second fixing mechanism may be connected to each other thus forming an integrity through the connection mechanism 3. Then the first fixing mechanism and the second fixing mechanism may be placed on both sides of the area that needs to be shielded, such as the kitchen, bathroom, stairway, balcony, etc. Then the handle mechanism 9 may be pulled to drive the rollup screen 6 to rotate about the screen rolling tube 5 so that driven by the handle mechanism 9 the rollup screen 6 will be able to shield the kitchen, bathroom, stairway, balcony or other areas. In addition, the handle mechanism 9 may be engaged with the hook seat thus achieving the purpose of fixing the handle mechanism 9. At this point, the rollup screen 6 is in an unfolded state, and can shield the kitchen, bathroom, stairway, balcony, or other areas, thus better restricting the range of children's activities.

After the rollup screen 6 is unfolded, the locking mechanism 15 may be turned to the locked state so that the screen rolling tube 5 would be locked and accordingly the rollup screen 6 would also be limited from rotating. The locking mechanism 15 can further improve the stability of the rollup screen 6 when the rollup screen 6 is in the unfolded state. The locking mechanism 15 can also increase the complexity of opening the doorway gate; in particular, because a linkage operation is required to open the gate, which is difficult for a child to imitate, thus effectively preventing the child from opening the doorway gate and further improving the safety performance of the doorway gate.

Under the action of the elastic force of the return spring 4, the rollup screen 6 would always be in a tendency of returning to the retracted state, so that the rollup screen 6 cannot extend outward. This avoids the possibility of falling off of the rollup screen 6 due to the extensibility of the material of the rollup screen 6 to the greatest extent, providing higher safety performance.

When the rollup screen 6 needs to be retracted, one just needs to switch the locking mechanism 15 from the locked state to the unlocked state to release the restriction imposed on the screen rolling tube 5 by the locking mechanism 15. Then the handle mechanism 9 may be removed from the hook seat. At this time, the hook seat no longer has a restrictive effect on the handle mechanism 9 and the rollup screen 6, so that under the action of the elastic force of the return spring 4, the rollup screen 6 would be automatically retracted. For an adult, especially an adult holding a child or some other object in one arm, the operation of opening or closing the gate is more convenient, thereby saving time and effort.

In order to enhance the stability of the safety gate when the rollup screen 6 is unfolded thus improving the safety performance of the doorway gate, a recess groove 23 may be provided in the screen rolling tube 5 as illustrated in FIGS. 1 and 8, and one end of the rollup screen 6 may be provided with a steel bar 24 that is interlocked with the recess groove 23. Through the interlocking of the steel bar 24 and the recess groove 23, the strength of the connection between the rollup screen 6 and the screen rolling tube 5 is further improved. In particular, when the rollup screen 6 is unfolded, one end of the rollup screen 6 may always be fixed in the groove 23 by the steel bar 24, thus improving the stability of the rollup screen 6 when it is unrolled.

Further, as shown in FIGS. 1, 2 and 3, the first fixing mechanism may be provided with a first support assembly 12, and the second fixing mechanism may be provided with a second support assembly 13. The first support assembly 12 and the second support assembly 13 can be arranged to facilitate supporting the first fixing mechanism and the second fixing mechanism on the respective mounting surfaces at the mounting position, providing ease for the mounting operation.

Further, as illustrated in FIGS. 1, 2 and 3, the connection mechanism 3 may include a connecting rod 301, a first connecting head 302, and a second connecting head 303. One end of the connecting rod 301 may be fitted with one end of the first connecting head 302, and the other end of the connecting rod 301 may be fitted with one end of the second connecting head 303. The other end of the first connecting head 302 is fitted with the first fixing mechanism, and the other end of the second connecting head 303 is fitted with the second fixing mechanism.

Thus, the first connecting head 302 is connected with the second connecting head 303 through the connecting rod 301, the first connecting head 302 is connected to the first fixing mechanism, and the second connecting head 303 is connected to the second fixing mechanism. In practical applications, because the spaces to be shielded in different areas, such as the kitchen, bathroom, stairway or balcony, may be different from each other, the length of the connecting rod 301 can be adjusted to accommodate to the installation dimensions in different areas having different widths, resulting in even higher adaptability.

Further, as illustrated in FIGS. 1, 2 and 3, the first fixing mechanism may include a first T-shaped rod 1 that is fitted with the first connecting head 302. The first mounting mechanism 7 and the second mounting mechanism 8 are both fixedly mounted on the first T-shaped rod 1. The first support assembly 12 is arranged on the first T-shaped rod 1. The first hook seat 101 is arranged on the second support assembly 13.

The first T-shaped rod 1 provides a stable support for the first mounting mechanism 7 and the second mounting mechanism 8. The arrangement of the first support assembly 12 facilitates the supporting of the first fixing mechanism on the respective mounting surfaces at the mounting position.

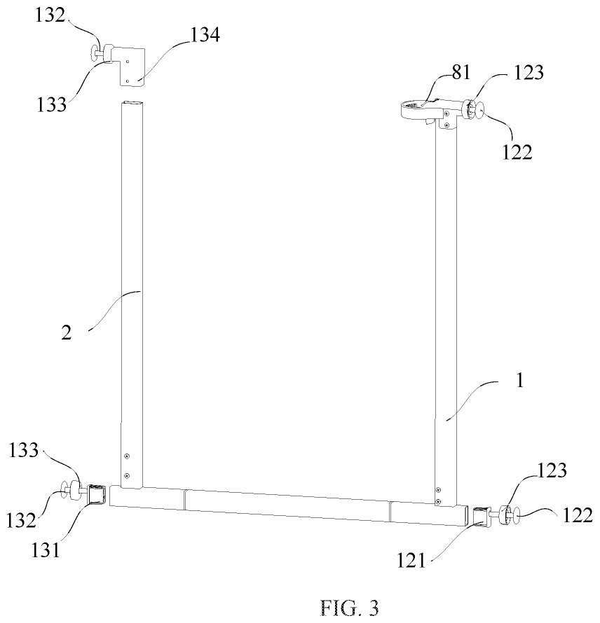

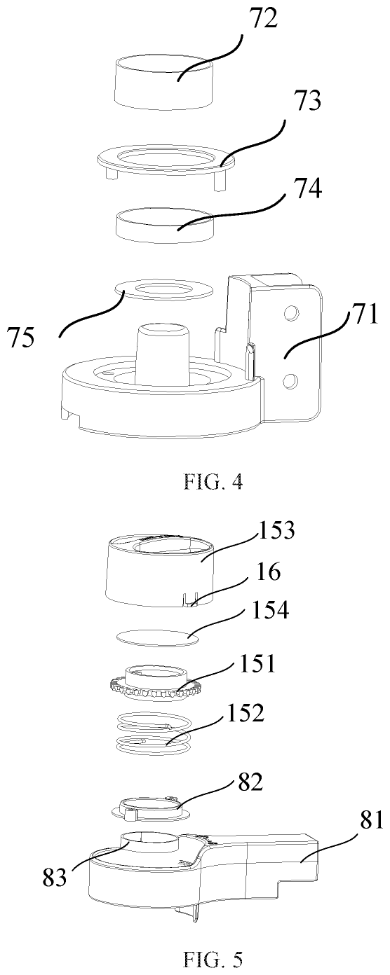

Further, as illustrated in FIGS. 1 and 4, the first mounting mechanism 7 includes a first mounting seat 71, a pressure ring 73, a rolling tube pad 72, a first washer 74, and a soft pad 75. The first mounting seat 71 is fixedly mounted on the first T-shaped rod 1. The soft pad 75 is installed in the first mounting seat 71. The first washer 74 is sleeved on top of the soft pad 75. The rolling tube pad 72 is arranged on the screen rolling tube 5. The rolling tube pad 72 and the screen rolling tube 5 are both fitted with the first mounting seat 71. The pressure ring 73 arranged set on the first mounting seat 71. The return spring 4 is fixedly connected to the first mounting seat 71.

During installation, the first mounting base 71 may be fixed to the first T-shaped rod 1 by a fastener such as a screw to maintain the stability of the doorway gate during operation. The return spring 4 is fixedly connected to the first mounting seat 71, so that the first mounting seat 71 can provide support for the return spring 4, which facilitates the stable operation of the return spring 4 when the rollup screen 6 is being retracted.

By fixedly installing the pressure ring 73 on the first mounting seat 71, the stability of the screen rolling tube 5 and the first mounting seat 71 during operation can be further improved. The rolling tube pad 72 is provided at the bottom end of the screen rolling tube 5, so that when a person pulls it by hand making the screen rolling tube 5 rotate to release the rollup screen 6, the rolling tube pad 72 at the bottom end of the screen rolling tube 5 will create friction with the soft pad 75 when rotating, while the outer wall of the screen rolling tube 5 may rub against the inner wall of the first washer 74, which can effectively reduce the frictional resistance caused by an uneven end surface of the screen rolling tube 5, facilitating the rotation of the screen rolling tube 5 and the pulling out of the rollup screen 6 during use of the doorway gate.

Further, as illustrated in FIGS. 1 and 5, the second mounting mechanism 8 may include a second mounting seat 81 and a mounting sleeve 82. The second mounting seat 81 is fixedly mounted on the first T-shaped rod 1. The mounting sleeve 82 is fixedly installed in the second mounting seat 81. The screen rolling tube 5 passes through the second mounting seat 81 to be fitted with the mounting sleeve 82. The locking mechanism 15 is arranged in the second mounting seat 81.

During installation, the mounting sleeve 82 may be fixed in the second mounting seat 81 by a fastener such as a screw. The mounting sleeve 82 may further fix the rollup screen 6 in the second mounting seat 81 to maintain the stability of the screen rolling tube 5 during operation of the doorway gate.

Further, as illustrated in FIG. 5, the second mounting mechanism 8 may further include a second washer 83. The top of the second washer 83 is fitted with the mounting sleeve 82, and the bottom of the second washer 83 is fitted with the second mounting seat 81. The second washer 83 may protect the surfaces of the second mounting seat 81 and the mounting sleeve 82, and prolong the overall service life of the doorway gate.

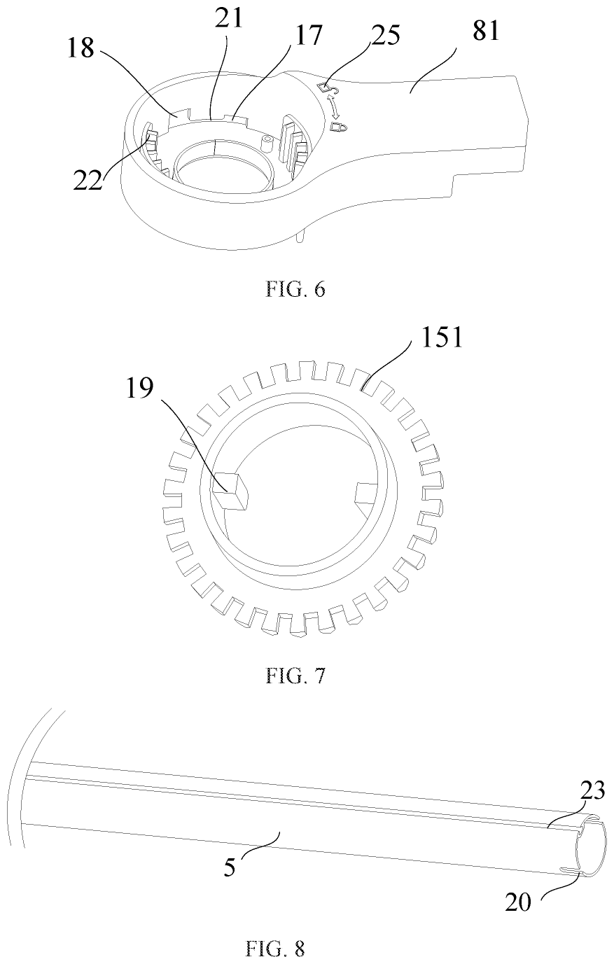

Further, as illustrated in FIGS. 5 and 6, a locking mechanism 15 is provided in the second mounting seat 81 for locking or unlocking the screen rolling tube 5, where the locking mechanism 15 is connected to the screen rolling tube 5.

As illustrated in FIGS. 5, 6, 7 and 8, the locking mechanism 15 includes a fixing gear 151, a locking spring 152, a knob 153, and a locking assembly. An engagement piece 22 is provided in the second mounting seat 81. One end of the locking spring 152 is fixedly connected to the second mounting seat 81, and the other end is fixedly connected to the fixing gear 151. The fixing gear 151 is installed on the screen rolling tube 5 and is operative to be engaged with the engagement piece 22 so that the screen rolling tube 5 cannot rotate relative to the second mounting seat 81. The fixing gear 151 may also move relative to the screen rolling tube 5 between the position where the fixing gear 151 is engaged with the engagement piece 22 and the position where the fixing gear 151 is disengaged from the engagement piece 22. The locking spring 152 is used to provide an elastic force for enabling the fixing gear 151 to be disengaged from the engagement piece 22. The knob 153 is movably mounted on the second mounting seat 81, and is used to push the fixing gear 151 so that the fixing gear 151 can be engaged with the engagement piece 22. The locking assembly is used to lock the knob 153 on the second mounting seat 81 so that the knob 153 can keep the fixing gear 151 engaged.

The locking assembly includes a snap protrusion 16 arranged on the knob 153, as well as a locking groove 17, a releasing groove 18, and a slide groove 21 that are provided in the second mounting seat 81, where the slide groove 21 is in communication with each of the locking groove 17 and the releasing groove 18. The snap protrusion 16 is slidably connected to the slide groove 21. The fixing gear 151 is provided with a limit block 19, and the screen rolling tube 5 is provided with a limit slot 20 that is operative to be engaged with the limit block 19.

When the snap protrusion 16 is located in the locking groove 17, the limit block 19 is engaged with the limit slot 20, and the limit block 19 will restrict screen rolling tube 5 from rotating. At this time, the screen rolling tube 5 is in a locked state, so that the doorway gate would have a higher safety performance for families that have children at home. When the snap protrusion 16 is located in the releasing groove 18, the limit block 19 is separated from the limit slot 20, and the limit block 19 no longer restricts the rotation of the screen rolling tube 5. At this time, the screen rolling tube 5 is in an unlocked state, and so under the action of the elastic force of the return spring 4, the rollup screen 6 would be automatically retracted.

Based on the above structure, in the practical operation, after the rollup screen 6 is pulled out and fixed, an external force may be exerted to make the knob 153 push against the fixing gear 151 thus making the fixing gear 151 be engaged with the engagement piece 22. Meanwhile, the knob 153 may be turned to make the snap protrusion 16 slide from the releasing groove 18 to the locking groove 17 through the slide groove 21. At this time, the limit block 19 is engaged with the limit slot 20, and so the limit block 19 restricts the screen rolling tube 5 from rotating. Thus, the screen rolling tube 5 is in a locked state at this point.

Analogously, when the locked state of the screen rolling tube 5 is to be released, one may press the knob 153 and then turn the knob 153, so that the snap protrusion 16 would be separated from the locking groove 17 and moved to the releasing groove 18 thus releasing the locked state of the knob 153 by the locking assembly. After that, under the action of the locking spring 152, the limit block 19 would be separated from the limit groove 20, and the fixing gear 151 would be separated from the engagement piece 22, thereby releasing the locked state of the screen rolling tube 5.

The locking mechanism 15 of the present application requires a continuous operation to release the locked state of the knob 153, which can restrain children and prevent them from opening the door by mistake.

The knob 153 may be provided with a mark 25 for distinguishing whether the knob 153 is in the unlocked or locked state, so that the user can confirm the state of the screen rolling tube 5.

Further, a slide aiding pad 154 may be provided in the knob 153, and it can speed up the operation of the knob 153 locking or unlocking the screen rolling tube 5, facilitating the unlocking or locking of the doorway gate by the user.

The slide aiding pad 154, the first washer 74, and the soft pad 75 may be constructed of Teflon material, which has stronger sliding properties and wear resistance.

Further, the second fixing mechanism may include a second T-shaped rod 2 that is fitted with the second connecting head 303. The second hook seat 102 and the second support assembly 13 are both arranged on the second T-shaped rod 2.

The second T-shaped rod 2 may provide a stable support for the hook seat and the second support assembly 13 thus ensuring the stability of the hook seat and the second support assembly 13 during operation.

Further, the first support assembly 12 may include a first pipe plug 121, two first screw rods 122, and two first adjusting nuts 123. The first pipe plug 121 is fitted with the first T-shaped rod 1. One of the first screw rods 122 passes through one of the first adjusting nuts 123 to be threadedly connected to the first pipe plug 121, and the other first screw rod 122 passes through the other first adjusting nut 123 to be threadedly connected to the second mounting seat 81.

In actual use, the two first adjusting nuts 123 can be adjusted to drive the two first screw rods 122 to be supported on the respective mounting surfaces at the mounting position at the same time, thus providing ease of installation and facilitating the stability of the first T-shaped rod 1 during installation.

Further, the second support assembly 13 may include a second pipe plug 131, a fixing pipe 134, two second screw rods 132, and two second adjusting nuts 133. The second pipe plug 131 and the fixing pipe 134 are both installed on the first T-shaped rod 2. One of the second screw rods 132 passes through one of the second adjusting nuts 133 to be threadedly connected to the second pipe plug 131, and the other second screw rod 132 passes through the other second adjusting nut 133 to be threadedly connected to the fixing pipe 134.

In actual use, the two corresponding second adjusting nuts 133 can be adjusted at the same time to drive the two second screw rods 132 to be supported on the respective mounting surfaces at the mounting position at the same time, thus providing ease of installation and facilitating the stability of the second T-shaped rod 2 during installation.

The cooperative use of the first support assembly 12 and the second support assembly 13 facilitates the supporting of the first T-shaped rod 1 and the second T-shaped rod 2 on the respective mounting surfaces at the installation position, providing ease of installation.

To further fix the rollup screen 6 after it is pulled out, the limit mechanism 10 may include a first hook seat 101 and a second hook seat 102. The first hook seat 101 is fixedly installed on the fixing pipe. The second hook seat 102 is fixedly installed on the second T-shaped rod 2. The handle mechanism 9 includes a handle rod 91, a first rod plug 92, and a second rod plug 93 that can be engaged with the first hook seat 101 and the second hook seat 102. The handle rod 91 is arranged at one end of the rollup screen 6. The first rod plug 92 and the second rod plug 93 are fixed on both ends of the handle rod 91. The rollup screen 6 is fixedly connected to the first rod plug 92 and to the second rod plug 93. After the handle rod 91 pulls out the rollup screen 6, the two ends of the handle rod 91 can be engaged with the first hook seat 101 and the second hook seat 102, thus achieving the purpose of fixing the position of the rollup screen 6.

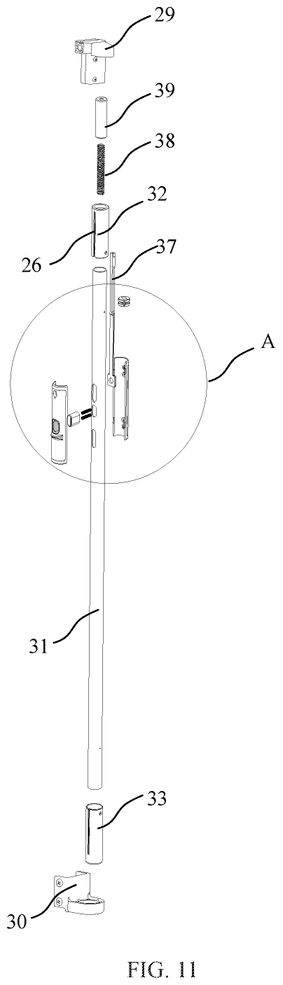

In order to enhance the connection strength of the safety gate, the first rod plug 92 and the second rod plug 93 may each be provided with a fixing slot 26 for the rollup screen 6 to pass through, as is illustrated in FIG. 10. By fixing the rollup screen 6 in the fixing slot 26, the situation that the rollup screen 6 shifts to both ends of the handle rod 91 can be avoided, which is beneficial to improve the stability of the rollup screen 6 during the operation of the doorway gate.

In actual use, the handle rod 91 drives the rollup screen 6 to shield the passageways in areas such as the kitchen, bathroom, stairway, or the balcony. By engaging the first rod plug 92 in the first hook seat 101 and the second rod plug in the second hook seat 102, the handle rod 91 can be fixed, thus ensuring that the rollup screen 6 is always in an unfolded state, avoiding the falling off of the rollup screen 6 and thus providing even higher safety performance.

Furthermore, the rollup screen 6 may be provided with a second notch 27 and a third notch 28 at positions corresponding to the handle rod 91. The portions of the handle rod 91 at the positions of the second notch 27 and the third notch 28 may facilitate the engagement of the handle rod 29 with the first hook seat 101 and the second hook seat 102.

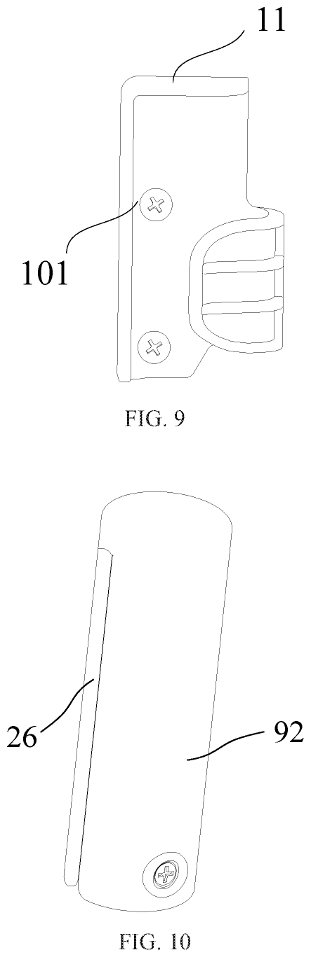

As illustrated in FIG. 9, in order to further restrict the first rod plug 92 and the second rod plug 93, the first hook seat 101 and the second hook seat 102 may each be fixedly provided with a stopping block 11, which can effectively improve the stability of the handle rod 91.

The cooperative use of the first rod plug 92 and the first hook seat 101, and the second rod plug 93 and the second hook seat 102 facilitates to improve the stability of the rollup screen 6 when the rollup screen 6 is in the unfolded state, resulting in even higher safety performance.

### Second Embodiment

The second embodiment is another embodiment of the present application, and differs from the first embodiment in that:

The handle mechanism 9 and the limit mechanism 10 are implemented by the following structure.

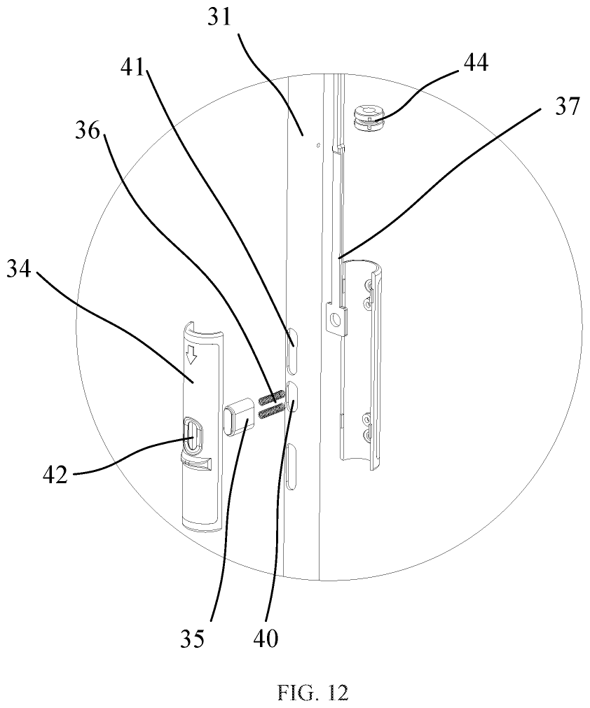

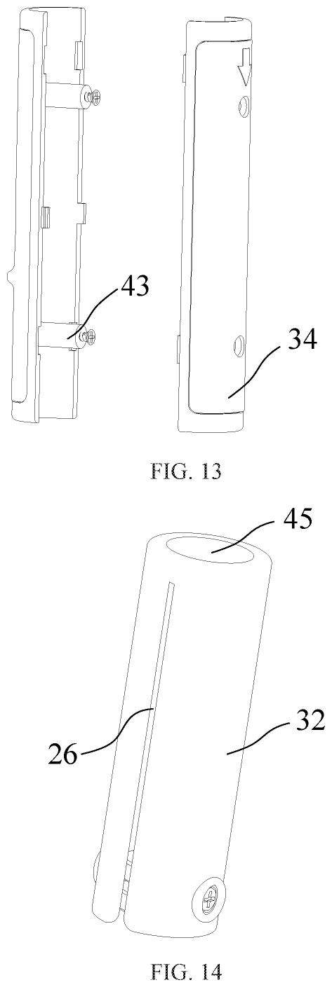

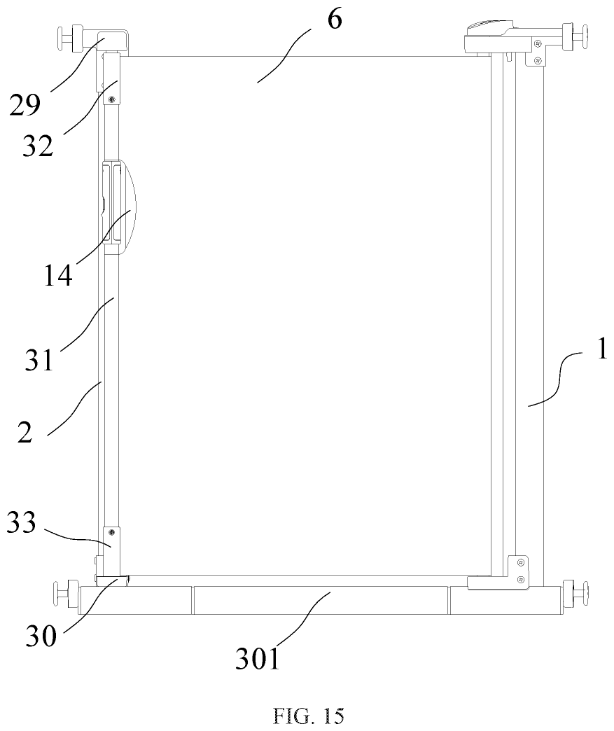

As illustrated in FIGS. 11 to 15, the handle mechanism 9 may include a handle tube 31, a first sleeve tube 32, a second sleeve tube 33, a handgrip 34, a locking button 35, a first elastic piece 36, a linkage rod 37, a second elastic piece 38, and a bolt 39. The first sleeve tube 32 is installed at one end of the handle tube 31. The second sleeve tube 33 is installed at the other end of the handle tube 31. The first sleeve tube 32 and the second sleeve tube 33 are both fixedly connected to the rollup screen 6. The handle tube 31 is sleeved on one end of the rollup screen 6.

The handle tube 31 is provided with a static button hole 40 and a guide hole 41. The handgrip 34 is provided with a movable button hole 42 and a linkage column 43. The static button hole 40 is stationary relative to the locking button 35 in the direction of gravity, while the movable button hole 42 is movable relative to the locking button 35 in the direction of gravity. The handgrip 34 is movably sleeved on the handle tube 31 to be operative to move along the axis of the handle tube 31. The locking button 35 can be movably inserted into the static button hole 40 so as to be operative to move along the axis of the static button hole 40 (so that the locking button 35 can be inserted into or disengaged from the movable button hole 42, thereby fixing the handgrip 34 to the handle tube 31 or unlocking the handgrip 34). The first elastic piece 36 is arranged in the handle tube 31 and connected to the locking button 35 (such as by way of sleeving, welding, or a screw), and is used to drive the locking button 35 to be inserted into the button hole 42 to fix the handgrip 34 to the handle tube 31. The linkage column 43 penetrates into the handle tube 31 through the guide hole 41, and is operative to move along the axis of the handle tube 31 in the guide hole 41. The linkage column 43 is connected to the linkage rod 37, for example, by way of welding, screwing, etc. The linkage column 43 is used to drive the linkage rod 37 to move in the vertical direction. The linkage rod 37 is arranged in the handle tube 31, and the top of the linkage rod 37 is fixedly connected to the bolt 39. The handle tube 31 is provided with a support block 44 therein, and the two ends of the second elastic piece 38 are connected to the bolt 39 and the support block 44, respectively, and the first sleeve tube 32 is provided with a through hole 45 through which the bolt 39 is operative to extend and retract. The second elastic piece 38 is used to drive the bolt 39 to extend from the inside of the handle tube 31 to the outside of the through hole 45.

The limit mechanism 10 includes a first fixing seat 29 and a second fixing seat 30. The first fixing seat 29 is fixedly installed on the fixing pipe 134. The second fixing seat 30 is fixedly installed on the second T-shaped rod 2. The first fixing seat 29 is provided with a first insertion hole (not shown in the figure) that can be fitted with the bolt 39. The second fixing seat 30 is provided with a second insertion hole (not shown in the figure) that can be fitted with the second sleeve tube 33. When the second elastic piece 38 is in an initial state, the bolt 39 is engaged with the first insertion hole. When the elastic piece 38 is in a compressed state, the second elastic piece 38 is operative to drive the bolt 39 to retract into the handle tube 31 along the through hole 45 to achieve the separation of the bolt 39 from the first insertion hole, thereby achieving the purpose of unlocking the handle tube 31 from the first and second insertion holes.

In order to improve the stability of the first fixing seat 29, the first fixing seat 29 may be integrally formed with the fixing pipe 134.

When using the safety gate according to this embodiment, the first fixing seat 29 and the second fixing seat 30 may be fixed to the fixing pipe 134 and the second T-shaped rod 2, respectively. At this time, the rollup screen 6 is all rolled up on the screen rolling tube 5, and one may pull the handle tube 31 by hand to rotate the screen rolling tube 5 to release the rollup screen 6. Then one may continuously press on the locking button 35, so that the locking button 35 will press the first elastic piece 36 to be detached from the movable button hole 42. Thus, the handgrip 34 will be unlocked from the handle tube 31, allowing the handgrip 34 to move along the axis of the handle tube 31. Then one may insert the second sleeve 33 at the bottom of the handle tube 31 into the second insertion hole. With the support of the second insertion hole, the handgrip 34 will move downward relative to the handle tube 31 under the action of the downward sliding force of the human hand. Thus, the linkage column 43 of the handgrip 34 will drive the linkage rod 37 to move downward. As such, the bolt 39 that is fixedly connected to the linkage rod 37 will also move downward following the linkage rod 37. As a result, the distance between the top end of the bolt 39 and the bottom end of the handle tube 31 is temporarily shortened, so that the plug 39 can be placed directly below the first insertion hole. Then one may release the force of the hand acted on the handgrip 34 so that the second elastic piece 38 will drive the bolt 39 to rise and slide out from the through hole 45 to be inserted into the first insertion hole, thus achieving the insertion of the bolt 39 into the first insertion hole, hence the closing of the safety gate. Furthermore, as the bolt 39 returns to its natural state, the linkage rod 37, the linkage column 43, and the handgrip 34 would also rise synchronously to return to their natural states. When the handgrip 34 is totally reset, the locking button 35 will be driven by the first elastic piece 36 to be inserted into the button hole 42 thus locking the handgrip 34.

Analogously, when the gate needs to be opened, one may again continuously press the locking button 35 by hand, and then pull the handgrip 34 downward, so that the bolt 39 slides out of the first insertion hole, and so the handle tube 31 can be removed from the first fixing seat 29 and the second fixing seat 30. At this time, because the return spring 4 is in a twisted state and has stored elastic potential energy, the screen rolling tube 5 will be rotated by the return spring 4 to retract the rollup screen 6 after being released by the person's hand.

Apparently, only by continuously pressing the locking button 35 by the hand can the handgrip 34 be slid down, so that the linkage column 43 of the handgrip 34 can drive the linkage rod 37 to move downward together, and accordingly the bolt 39 fixed to the linkage rod 37 would descend along with the linkage rod 37, allowing the handle tube 31 to be taken out. Thus, the process of opening or closing the gate can be easily completed with only one hand, which is not only convenient for an adult to operate, but it is also difficult for a child to imitate because the door opening process requires a continuous operation, thereby effectively preventing the child from opening the doorway gate.

The first elastic piece 36 and the second elastic piece 38 may be conventional elastic elements such as springs, elastic rubber bands, elastic silicone, etc.

To strengthen the connection strength of the safety gate so that the safety gate is not prone to damage, the safety gate according to the second embodiment is also provided with fixing slots 26 in the tube walls of the first sleeve tube 32 and the second sleeve tube 33 arranged at both ends of the handle tube 31 that are used for the rollup screen 6 to pass through, thus increasing the connection strength between the rollup screen 6 and the first and second sleeve tubes 32 and 33. In addition, the rollup screen 6 is provided with a first notch 14 on the side close to the handle tube 31, and the handgrip 34 is accommodated in the first notch 14 so that the handgrip 34 can be conveniently operated by the person's hand.

When installing the safety gate according to the present disclosure, the first mounting mechanism 7 and the second mounting mechanism 8 are fixed to the first fixing mechanism, the limit mechanism 10 is fixed to the second fixing mechanism 8, and the first fixing mechanism 7 and the second fixing mechanism 8 are connected together by the connection mechanism 3. Thus, the contact object such as the wall or door frame would not necessarily be damaged by the installation of the safety gate, making the installation more convenient.

The foregoing merely depicts some illustrative embodiments according to this disclosure, and the scope of protection of this disclosure will not be limited to the foregoing embodiments. All technical solutions under the spirit of the present disclosure shall belong to the scope of protection of this disclosure. For those having ordinary skill in the art, numerous improvements and modifications made without departing from the principles of the present disclosure should also be regarded as fall in the scope of protection of this disclosure.

What is claimed is:

1. A safety gate, comprising:
a first fixing mechanism;
a second fixing mechanism;
a connection mechanism;
a return spring;
a screen rolling tube; and
a rollup screen, operative to be wound on the screen rolling tube; wherein one end of the screen rolling tube is provided with a first mounting mechanism, and another end of the screen rolling tube is provided with a second mounting mechanism; wherein one end of the return spring passes through the screen rolling tube to be fixedly connected to one end of the rollup screen, and another end of the return spring is fixedly connected to the first mounting mechanism; wherein a locking mechanism is provided in the second mounting mechanism and configured for locking or unlocking the screen rolling tube, and the locking mechanism is fixedly connected to the screen rolling tube; wherein another end of the rollup screen is provided with a handle mechanism configured for pulling the rollup screen; wherein one end of the connection mechanism is fitted with the first fixing mechanism, and another end of the connection mechanism is fitted with the second fixing mechanism; wherein the first mounting mechanism and the second mounting mechanism are each fixedly mounted on the first fixing mechanism; and wherein the second fixing mechanism is provided with a limit mechanism operative to be engaged with the handle mechanism.

2. The safety gate of claim 1, wherein the first fixing mechanism is provided with a first support assembly, and the second fixing mechanism is provided with a second support assembly.

3. The safety gate of claim 2, wherein the connection mechanism comprises a connecting rod, a first connecting head, and a second connecting head, wherein one end of the connecting rod is fitted with one end of the first connecting head, and another end of the connecting rod is fitted with one end of the second connecting head, wherein another end of the first connecting head is fitted with the first fixing mechanism, and another end of the second connecting head is fitted with the second fixing mechanism.

4. The safety gate of claim 3, wherein the first fixing mechanism comprises a first T-shaped rod fitted with the first connecting head, wherein the first mounting mechanism and the second mounting mechanism are both fixedly mounted on the first T-shaped rod, and wherein the first support assembly is arranged on the first T-shaped rod.

5. The safety gate of claim 4, wherein the first mounting mechanism comprises a first mounting seat, a pressure ring, a rolling tube pad, a first washer, and a soft pad, wherein the first mounting seat is fixedly mounted on the first T-shaped rod, the soft pad is installed in the first mounting seat, the first washer is sleeved on top of the soft pad, the rolling tube pad is arranged on the screen rolling tube, wherein the rolling tube pad and the screen rolling tube are each fitted with the first mounting seat, the pressure ring is arranged on the first mounting seat, and the return spring is fixedly connected to the first mounting seat.

6. The safety gate of claim 4, wherein the second mounting mechanism comprises a second mounting seat and a mounting sleeve, wherein the second mounting seat is fixedly mounted on the first T-shaped rod, the mounting sleeve is fixedly installed in the second mounting seat, the screen rolling tube passes through the second mounting seat to be fitted with the mounting sleeve, and the locking mechanism is arranged in the second mounting seat.

7. The safety gate of claim 6, wherein the first support assembly comprises a first pipe plug, two first screw rods, and two first adjusting nuts, wherein the first pipe plug is fitted with the first T-shaped rod, one of the first screw rods passes through one of the first adjusting nuts to be threadedly connected to the first pipe plug, and another first screw rod passes through another first adjusting nut to be threadedly connected to the second mounting seat.

8. The safety gate of claim 3, wherein the second fixing mechanism comprises a second T-shaped rod that is fitted with the second connecting head, wherein the limit mechanism and the second support assembly are each arranged on the second T-shaped rod.

9. The safety gate of claim 8, wherein the second support assembly comprises a second pipe plug, a fixing pipe, two second screw rods, and two second adjusting nuts, wherein the second pipe plug and the fixing pipe are each installed on the second T-shaped rod, one of the second screw rods passes through one of the second adjusting nuts to be threadedly connected to the second pipe plug, and another second screw rod passes through another second adjusting nut to be threadedly connected to the fixing pipe.

10. The safety gate of claim 9, wherein the limit mechanism comprises a first fixing seat and a second fixing seat, wherein the first fixing seat is fixedly installed on the fixing pipe, and the second fixing seat is fixedly installed on the second T-shaped rod, wherein the handle mechanism comprises a handle tube, a first sleeve tube, a second sleeve tube, a handgrip, a locking button, a first elastic piece, a linkage rod, a second elastic piece, and a bolt, wherein the first sleeve tube is installed at one end of the handle tube, the second sleeve tube is installed at another end of the handle tube, and both the first sleeve tube and the second sleeve tube are each fixedly connected to the rollup screen, wherein the handle tube is sleeved on one end of the rollup screen, the handle tube is provided with a static button hole and a guide hole, the handgrip is provided with a movable button hole and a linkage column, the handgrip is movably sleeved on the handle tube; the locking button is operatively to be movably inserted into the static button hole; the first elastic piece is installed in the handle tube and fixedly connected to the locking button; the first elastic piece is configured to drive the locking button to be inserted into the movable button hole to fix the handgrip on the handle tube; the linkage column penetrates into the handle tube along the guide hole; the linkage rod is arranged in the handle tube; the handle tube is provided with a support block therein; the linkage column is connected to one end of the linkage rod, and another end of the linkage rod passes through the support block and the second elastic piece to be fixedly connected to the bolt; one end of the second elastic piece is fixedly connected to the bolt, and another end of the second elastic piece is fixedly connected to the support block; wherein the first sleeve tube is provided with a through hole allowing the bolt to extend and retract; the first fixing seat is provided therein with a first insertion hole that is operative to be fitted with the bolt, and the second fixing seat is provided therein with a second insertion hole that is operative to be fitted with the second sleeve tube.

11. The safety gate of claim 10, wherein the first sleeve tube and the second sleeve tube are each provided with a fixing slot configured for the roll screen to pass through, and the rollup screen is provided with a first notch configured on the side close to the handle tube, and wherein the handgrip is accommodated in the first notch.

12. The safety gate of claim 9, wherein the limit mechanism comprises a first hook seat and a second hook seat, wherein the first hook seat is fixedly installed on the fixing pipe, and the second hook seat is fixedly installed on the second T-shaped rod, wherein the handle mechanism comprises a handle rod, a first rod plug, and a second rod plug that are operative to be engaged with the first hook seat and the second hook seat, wherein the handle rod is arranged at one end of the rollup screen, the first rod plug and the second rod plug are fixed on both ends of the handle rod, and wherein the rollup screen is fixedly connected to the first rod plug and to the second rod plug.

13. The safety gate of claim 12, wherein the first rod plug and the second rod plug are each provided with a fixing slot configured for the roll screen to pass through, and wherein the rollup screen is provided with a second notch and a third notch at positions corresponding to the handle rod.

14. The safety gate of claim 1, wherein the screen rolling tube is provided with a slot, and one end of the rollup screen is provided with a steel strip that is operative to be interlocked with the slot.
